(19) United States
(12) Patent Application Publication
(10) Pub. No.: US 2010/0290141 A1
(43) Pub. Date: Nov. 18, 2010

(54) Rearview mirror having container

(76) Inventor: Wen Huang, Tainan (TW)

Correspondence Address: Wen HUANG, No. 149, ( Room 9, 10/F.), Lin Sen Road, Sec. 1, Tainan, 701, TW

(21) Appl. No.: 12/454,372

(22) Filed: May 18, 2009

(51) Int. Cl. B60R 1/12

(52) U.S. Cl. 359/844

(57) ABSTRACT

A rearview mirror includes a container, locating alternatively on the top or bottom of the rearview mirror, where the opening of the container is provided with a movable lid and a wide-angle mirror is embedded in the front side of the lid. By means of placing the container on top or bottom of the rearview mirror, things could be stored therein, and the wide-angle rear view would enable the driver to know well the status of the vehicles that follow.

### BACKGROUND OF THE INVENTION

1. Field of the Invention

This invention relates generally to rearview mirrors having a container and more particularly to a rearview mirror that positions alternatively the container on its top or bottom.

2. Description of the Prior Art

Most vehicles are provided with a rearview mirror. And drivers are therefore able to watch the vehicles that follow. Usually drivers prevent sunshine from directly irradiating their eyes that could bring about jeopardy to the driving, so that a pair of sunglasses is always prepared just in case. However, the front container of cars is almost all located in front of the non-driver seat, where the sunglasses placed in that container is too far to be fetched by the driver during the driving, which is awfully unhandy to the driver. In the light of the aforementioned drawbacks, this inventor conceived the idea for the advanced improvement, and eventually the longtime endeavors gave birth to this invention.

### SUMMARY OF THE INVENTION

The main objective of this invention is to provide a rearview mirror with a container that eases the driver to fetch the intended article in the container.

The other objective of this invention is to provide a container lid that also features a wide-angle mirror.

To achieve the aforementioned objectives, the rearview mirror of this invention is joined fixedly with a container on its top or its bottom, where the opening of the container is provided with a movable lid, and a wide-angle mirror is embedded in the front surface of the lid; by means of the container fixing on the top or bottom of the rearview mirror, articles could be stored therein, and the wide-angle rear view would enable the driver to know well the status of the vehicles that follow.

### BRIEF DESCRIPTION OF THE DRAWINGS

FIG. 1 is a three-dimensional view of the structure according to the exemplary embodiment of this invention;

FIG. 2 is an exploded view according to the exemplary embodiment of this invention;

FIG. 3 is a schematic view of the lifted lid according to the exemplary embodiment of this invention;

FIG. 4 is a schematic view of the closed lid according to the exemplary embodiment of this invention; and

FIG. 5 is a three-dimensional back view according to the exemplary embodiment of this invention.

### DETAILED DESCRIPTION OF THE INVENTION

To achieve the aforesaid objectives of this invention, the techniques adopted and the achievable functions are detailed described with reference to the following preferred exemplified embodiment and the accompanying drawings for a thorough comprehension.

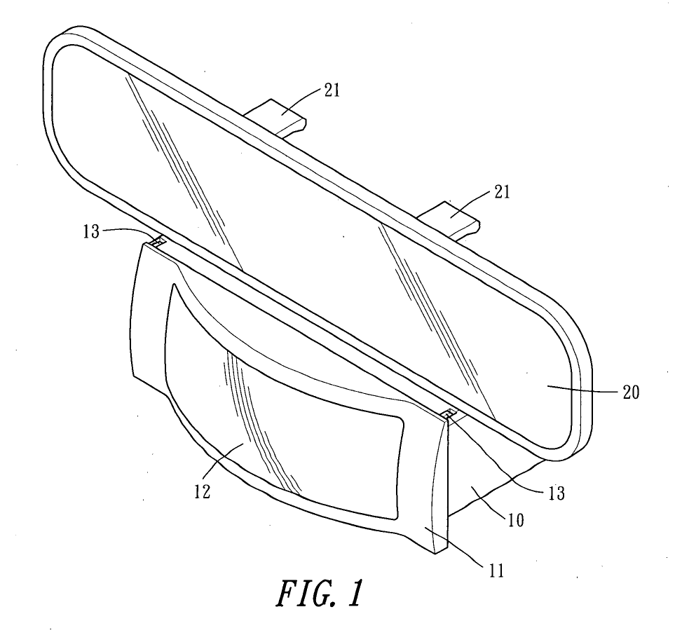

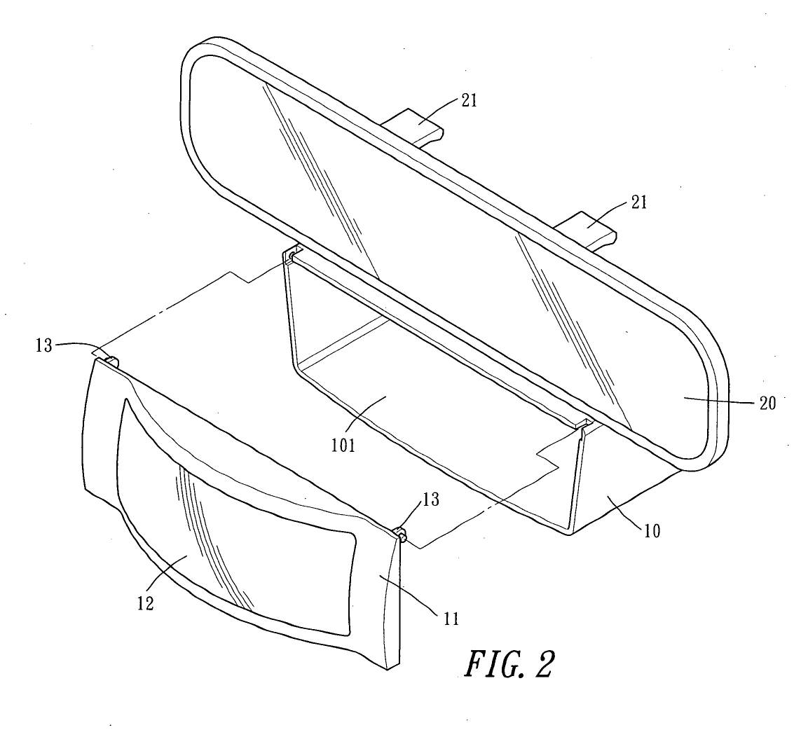

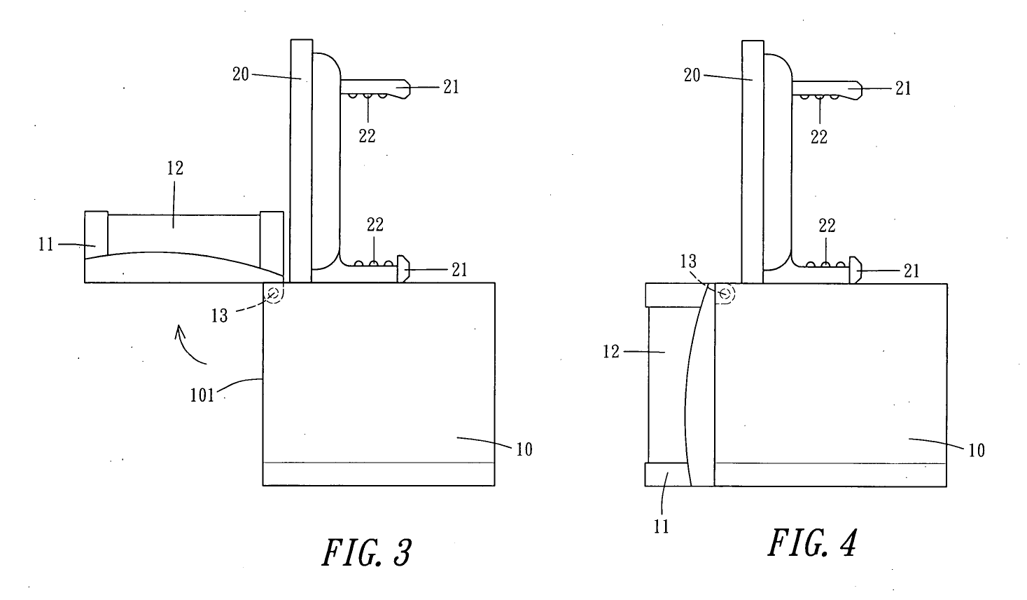

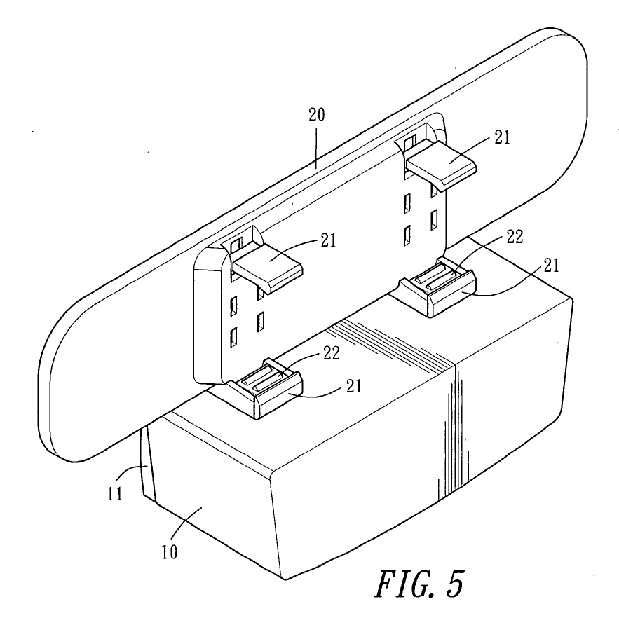

Referring to FIGS. 1 & 2, this invention is to provide a rearview mirror 20 with a container 10 joined fixedly (can be formed into an all-in-one) at its bottom (the container 10 can be also set up on its top), where the container 10 is used for keeping articles. The container 10 is provided with a lid 11 on its opening 101, where the top portion of the lid 11 and the top portion of the opening 101 of the container 10 are in pivotal connection, which enables the lid 11 to be lifted up when articles are put in or taken out. The lid 11 is in the shape of an arc, where a wide-angle mirror 12 is embedded in its front surface. The rearview mirror 20 is provided with two pairs of clamping devices 21 at both right and left of its back. The top or bottom clamping device 21 of each pair is provided with a spring for offering both stretching and clamping features. The top and bottom clamping devices 21 of each pair are provided with malleable snap bulges 22 on the side facing to each other (shown in FIGS. 3-5). By means of the two pairs of clamping devices 21 fixing at the left and right of the backside of the rearview mirror 20, the rearview mirror 20 can be placed over the original rearview mirror by a clamping. The top and bottom clamping devices 21 of the rearview mirror 20 can be replaced by a fixing arm, where the original rearview mirror has first to be torn down and the fixing arm can then be fixed directly on the top interior surface. When using this invention, the user lifts the lid 11 up, places articles in and lays the lid 11 down for depositing something in the container 10. Since the container 10 is located on bottom (or top) of the rearview mirror 20, and the rearview mirror 20 is at the front top of the middle of the front seats, it is awfully handy for the diver to fetch an article (for instance sunglasses) or deposit it in the container 10 during driving, which is within the distance of a hand.

The lid 11 at the front of the container 10 features not only a cap for the covering but a wide-angle mirror for diminishing the dead space for the rear view.

This invention is provided with a container 10 fixing at the bottom (or top) of the rearview mirror 20 for keeping articles additionally, which also enable the driver to put in or take out the things to/from the container 10 within the distance of a hand during driving. The lid 11 of the container 10 is provided with a wide-angle mirror 12 embedded in its front side, diminishing the dead space for the rear view, which makes this invention much useful and creative than the prior art.

To sum up, the present invention is absolutely able to accomplish the expected objectives and functions, and the detailed description is complete enough for those skilled in the art to realize the invention; the aforesaid exemplified embodiment of the present invention is only used for describing this invention. Any equivalent embodiments or modifications without departing from the spirit and scope of the present invention are therefore intended to be embraced.

What is claimed is:

1. A rearview mirror with a container, comprising:
a.) a rearview mirror;
b.) a container, joined fixedly to said rearview mirror, having an opening at the front side thereon, where the opening is in pivotal connection with a lid.

2. A rearview mirror with a container as in claim 1 wherein said container is set up at the bottom of said rearview mirror.

3. A rearview mirror with a container as in claim 1 wherein said container is set up at the top of said rearview mirror.

4. A rearview mirror with a container as in claim 1 wherein the lid is in the shape of an arc and embeds a wide-angle mirror.

5. A rearview mirror with a container as in claim 1 wherein said rearview mirror is provided with two pairs of clamping devices at both right and left of its backside, and the top or bottom clamping device of each pair being provided with a spring for offering both stretching and clamping features, where the top and bottom clamping devices of each pair are provided with malleable snap bulges on the side facing to each other, by means of the two pairs of clamping devices set up at the left and right of the backside of said rearview mirror, said rearview mirror being placed over the original rearview mirror with a clamping.

6. A rearview mirror with a container as in claim 1 wherein said rearview mirror may be provided with a fixing arm, where the fixing arm is fixed directly on the top interior surface of the car.
